(19) United States
(12) Patent Application Publication
(10) Pub. No.: US 2004/0215783 A1
(43) Pub. Date: Oct. 28, 2004

(54) Method for establishing a communications link

(75) Inventor: Hanno Hensing, Heidelberg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: WEB.DE AG, Karlsruhe (DE)

(21) Appl. No.: 10/423,697

(22) Filed: Apr. 25, 2003

(51) Int. Cl. G06F 15/16

(52) U.S. Cl. 709/227; 709/206

(57) ABSTRACT

A method for establishing a communications link between a first end user unit and a second end user unit includes communicating web site data from the first end user unit to a web site. The web site data are capable of activating the web site. A communications link unit is determined by the web site, the communications link unit providing communications links. The communications link is established between the first end user unit and the second end user unit via the communications link unit.

### BACKGROUND

In general, the present invention relates to a communications link between end user units in a communications environment on the basis of so-called “call-by-call” communications links. In particular, the present invention relates to establishing a call-by-call communications link between at least two end user units at least partially under control of a general-purpose communications interface referred to herein as a telecommunications web site.

In traditional telephone networks that do not service call-by-call communications links all telephones of a common telephone network are unchangeably associated with the provider of that telephone network. For establishing a communications link between a calling telephone and a telephone to be called, a telephone number identifying the telephone to be called is input into the calling telephone and transmitted via the telephone network to switching units and devices in the network.

On the basis of the telephone number of the telephone to be called, the switching units and devices establish a telephone connection (a communications link) between the calling telephone and the telephone to be called within that network.

Here, one drawback is the fact that telephones of such traditional telephone networks are operated according to the network characteristics given by the respective network provider. For example, a user of a traditional telephone network must accept the telephone costs of the network provider, must fulfill the technical requirements of the network (e.g., telephones according to a specific standard defining, inter alia, plug-socket connections, transmission rates, bandwidths, signaling and the like), is limited to services of the network provider (e.g., conventional telephone calls at a low transmission rate, data transmissions at transmission rates defined by the network provider), and is limited to communications links in the telephone network unless the service provider allows for communications links for specific other networks (e.g., international telephone calls but not communications to computer based networks).

In order to improve the service quality of telephone networks so-called “call-by-call” telephone calls are increasingly used in Public Switched Telephone Network (PSTN)-based telephone networks. Here, a telephone is still associated with a telephone network of a specific network provider but is allowed to establish communications links provided by a different service provider for that network. To establish such communications links via a service provider, a telephone connection between a calling telephone and the service provider is established by transmitting a telephone number identifying the service provider and a telephone connection between the service provider and a telephone to be called on the basis of a telephone number identifying the telephone to be called.

In particular, the calling telephone transmits the service provider telephone number to the network provider, which connects the calling telephone to the service provider. The network provider subsequently transmits the telephone number of the telephone to be called via the established telephone connection to the service provider. In response, the service provider establishes a telephone connection to the telephone to be called.

The transmission of a service provider telephone number can be initiated by manually inputting a service provider telephone number into a telephone or by automatically transmitting a service provider telephone number under control of a calling telephone or a so-called pre-dial add-on hard/software component in response to an input of a telephone number of a telephone to be called.

### SUMMARY OF THE INVENTION

Although “call-by-call” services provide for some enhancement in telephone communications, there are still a number of problems and constraints. For example, manually inputting a service provider telephone number requires additional user-telephone interaction which is time consuming and requires the user's concentration since most of the service provider telephone numbers include many digits. As a result, many telephone users will avoid the required additional interaction and, thus, not use call-by-call services.

Manually inputting a service provider telephone number can be avoided by automatic transmission of a service provider telephone number. However, manually inputting a service provider telephone number leaves open the option to choose different service providers, for example in view of telephone costs or transmission rates. In contrast, automatic transmission of the service provider telephone number is usually limited to a specific service provider telephone number. As a result, a user employing an automatic service provider transmission is virtually fixedly associated with that respective service provider. The result is a situation comparable to that with a traditional telephone network, as described above.

Moreover, common call-by-call services are not provided in mobile telephone networks (e.g., Global System for Mobile Communications (GSM) networks, Universal Mobile Telecommunications System (UMTS) networks). The same applies for communications performed via a computer network (e.g., the Internet) wherein a communications link to a computer network service provider can be established via a “call-by-call” telephone connection while communications links via the computer network are serviced by the computer network service provider a calling telephone is associated with. The latter problem can be overcome by service contracts with different computer network service providers. In practice this is rarely done since it is not user friendly; for each computer network communications link a desired computer network service provider must be chosen. Further, corresponding hardware and software must be installed by the user. Such installation is often rather complicated and can be costly, and therefore is often avoided.

The present invention provides a method for establishing a communications link between a first end user unit and a second end user unit. The method includes communicating first web site data from the first end user unit to a first web site, the first web site data being capable of activating the first web site; determining a first communications link unit using the first web site; and establishing a first communications link between the first end user unit and the second end user unit via the first communications link unit.

The present invention also provides an end user unit for communicating with a receiving end user unit. The end user unit includes at least one first unit configured to communicate first web site data to a first web site associated with the end user unit, the first web site data being capable of activating the first web site. Also included is at least one second unit configured to communicate with the receiving end user unit over a communications link via a first communications link unit determined by the first web site.

A web site for providing a first communications link between a first end user unit and a second end user unit is also provided by the present invention. The web site includes a web page associated with a user of the end user unit, and a processor configured to: receive web site data from the first end user unit, the web site data being capable of activating the web site; determine a communications link unit, the communications link unit configured to provide communications links; and initiate an establishment of the communications link between the first end user unit and the second end user unit via the communications link unit.

Also provided by the present invention is a computer readable medium having stored thereon computer executable process steps operative to perform a method for establishing a communications link between a first end user unit and a second end user unit. The method includes receiving, at a web site, web site data from the first end user unit, the web site data being capable of activating the web site; determining a communications link unit, the communications link unit configured to provide communications links; and initiating an establishment of the communications link between the first end user unit and the second end user unit via the communications link unit.

The present invention also provides a communications environment including a first end user unit and a web site associated with the first end user. The web site is configured to: receive web site data from the first end user unit, the web site data being capable of activating the web site; determine a communications link unit, the communications link unit configured to provide communications links; and initiate an establishment of the communications link between the first end user unit and a second end user unit via the communications link unit.

The present invention overcomes problems and constraints of known approaches proposed for “call-by-call” service, and provides a solution offering “call-by-call” services in a user friendly manner, requiring no or a minimum additional hardware and software components and being not limited to specific communications environments.

### BRIEF DESCRIPTION OF THE DRAWINGS

In the following description, the present invention is elaborated upon based on exemplary embodiments, with reference to the drawings.

FIG. 1 shows a schematic diagram depicting the establishment of a communications link between a first end user unit and a second end user unit using a telecommunications web site, according to a first embodiment of the present invention.

FIG. 2 shows a schematic diagram depicting the establishment of a communications link between a first end user unit and a second end user unit using a telecommunications web site, according to a second embodiment of the present invention.

FIG. 3 shows a schematic diagram depicting the establishment of a communications link between a first end user unit and a second end user unit using a telecommunications web site, according to a third embodiment of the present invention.

FIG. 4 shows a schematic diagram depicting the establishment of a communications link between a first end user unit and a second end user unit using a telecommunications web site, according to a fourth embodiment of the present invention.

FIG. 5 shows a schematic diagram depicting the establishment of a communications link between a first end user unit and a second end user unit using a telecommunications web site, according to a fifth embodiment of the present invention.

FIG. 6 shows a schematic diagram depicting the establishment of a communications link between a first end user unit and a second end user unit using a telecommunications web site, according to a sixth embodiment of the present invention.

FIG. 7 shows a schematic diagram depicting an end user unit.

FIG. 8 shows a schematic diagram of the architecture of an embodiment of the communication environment according to the present invention.

### DETAILED DESCRIPTION

In an embodiment the present invention provides a method for establishing a communications link between a first end user unit and a second end user unit. The method comprises communicating from the first end user unit to a first telecommunications web site first telecommunications web site-data, the first telecommunications web site-data activating the first telecommunications web site, determining a first communications link unit by the first telecommunications web site, the first communications link unit providing communications links, and establishing a communications link between the first end user unit and the second end user unit via the first communications link unit.

For carrying out the present invention, at least the following devices may be used: an end user unit from which a desired communications link is intended to originate, a telecommunications web site associated with the end user unit, and an end user unit to which the desired communications link is intended.

An end user unit as used herein refers to any of a variety of devices or unit which can be used for communications. For example, an end user unit may be a telephone, a keyboard, a computer terminal, a mobile phone, a fax, a telex, a mail pigeon, an ordinary letter, a scanner, a PSTN device, a 3G-wireless communications device, especially a UMTS device, etc., or a combination of two or more of these.

The end user unit of the present invention is not limited to a particular communications unit/device or any communications network. Rather, communications using an end user unit can occur via any of a variety of communications networks such as telephone networks, mobile communications networks, computer networks, radio transmission networks, the Internet, etc. Further, as noted above, an end user unit is not restricted to a single device, but can also include two and more devices providing data/information sending and/or receiving capabilities for communications purposes, e.g., an ordinary letter and a scanner.

The end user unit is adapted to perform network-based communications. Thus, the end user unit is connectable to a network and able to communicate with a network. A network in this context is a physical transport medium in which data and/or signals can be fed. For example, an ordinary letter itself is adapted to perform network-based communication when scanned or digitized and supplied into a TCP/IP network.

A “communications environment” as used herein may refer to a communications system comprising more than one component, i.e., more than one device and/or type of device, media and/or type of media, network and/or type of network. Thus, a communications environment or communications system might for instance comprise a telephone, a PSTN-network, a gateway to the Internet, etc.

The terms “web site” and “web page” refer to sites and sub-sites associated thereto which can be uniquely addressed by means of a single address, like a telephone number or an IP address, an URL, etc. It is also advantageous to use such a “web site” in a 3G-communication environment, especially an UMTS-environment. Preferably, such a web site is a site known from the Internet with a specific URL, which can be accessed by Internet visitors, and by the web site host. The web site host is the owner of the web site.

This web site can include one or more web pages. These web pages are part of the one web site. It should be noted that the terms “web site” and “web page” are not to be considered to limit the present invention to conventional web sites and web pages known from the Internet. Thus, the web site and its web page(s), respectively, can be accessed by establishing a communications link from an end user unit independently of the network(s) employed.

A telecommunications web site may be a web site adapted to provide, upon an access by an end user unit, for private communications between the accessing end user unit and an end user unit to which a communications link is to be established. Properties and functions of a telecommunications web site are described in commonly-assigned U.S. patent application Ser. No. 10/201,446, entitled “Communications Environment,” filed Jul. 23, 2002, and in commonly-assigned U.S. patent application Ser. No. 10/354,709, entitled “Web Site Having an Event Identification Element,” filed on Jan. 29, 2003, both of which are hereby incorporated by reference herein.

The terms “telecommunications web site” and “web site” may be understood to encompass software and hardware components effecting the site. Such components may include one or more processors, for example.

A telecommunications web site is assigned to or personalized for or corresponds to a specific person or entity. Such a specific entity can be a person, a company or any other entity. Preferably, the specific entity is a single entity, e.g., a specific user or owner (e.g., a single person, a company, a unit of a company, etc.) of the telecommunications web site, a specific address, a specific location, a specific end user unit and the like. Thus, an end user unit of a user to whom a telecommunications web site is associated to will be also associated with that telecommunications web site if used for accessing the telecommunications web site. Therefore, the specific entity with which a telecommunications web site is associated and an end user unit employed by the specific entity can in some embodiments be considered as synonymous for the period of time the specific entity operates its end user unit to access its telecommunications web site.

A telecommunications web site serves as a general purpose communications interface for an end user unit or an addressed entity, which may include or be an end user unit itself. As an illustration, the telecommunications web site can be considered as a communications “window”, similar to a window of an office counter, where communicating parties are “sitting” on opposite sides of the window and can communicate through speech holes in the window, via an intercom, by gestures, by facial expressions, showing papers with information written thereon, passing documents through a hatch and so on. Comparable thereto, the telecommunications web site according to the present invention allows communications in a plurality of modes and by a plurality of types/formats of data/information.

A telecommunications web site may be capable of providing and establishing multiprotocol communications, i.e., communications using different types of communications links. A multiprotocol connection may include different types of communications links, such as links of PSTN-networks, UMTS-networks, TCP/IP based networks, etc. For example, the connection of a telephone in a PSTN-network to a UMTS device in an UMTS-includes is a multiprotocol connection. Such a connection in parallel with a connection of a computer in a TCP/IP based network to another computer in a TCP/IP based network is also a multiprotocol connection as herein defined. Thus, a parallel use of different types of communications links is a multiprotocol connection. The individual links may carry various types of communications media (voice, data, video, etc.).

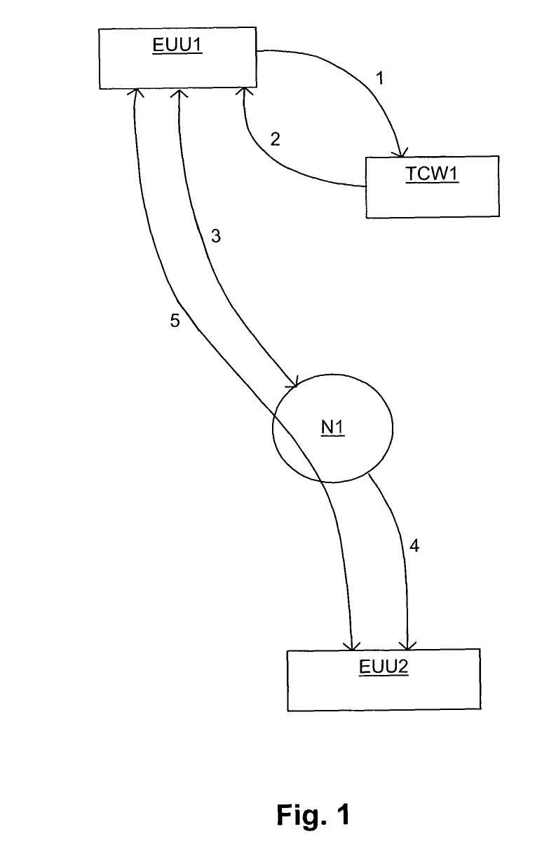

FIG. 1 shows a schematic diagram depicting the establishment of communications link 5 between first end user unit EUU1 and second end user unit EUU2 using first telecommunications web site TCW1. First telecommunications web site TCW1 is associated with first end user unit EUU1. First end user unit EUU1 may thus be an end user unit of a specific entity associated with first telecommunications web site TCW1.

To establish the desired communications link, first telecommunications web site TCW1 is activated or “opened”. For that purpose, telecommunications web site data (TCW data) are communicated (see arrow 1) by first end user unit EUU1 to first telecommunications web site TCW1. For example, first end user unit EUU1 may connect to telecommunications web site TCW1 utilizing a so-called “#0800-service” in a telephone network providing telephone calls free of charge for the calling party.

TCW data may include data/information required to allow an access of first telecommunications web site TCW1 by first end user unit EUU1 and data/information required by first telecommunications web site TCW1 to at least initiate an establishment of a desired communications link.

Data/information for accessing first telecommunications web site TCW1 include data characterizing first telecommunications web site TCW1 and may include, for security reasons, data identifying first end user unit EUU1 as an authorized user and/or authorizing first end user unit EUU1 or its user to access first telecommunications web site TCW1.

Data/information suitable for security purposes include so-called caller recognition of a user of first end user unit EUU1, for example PIN codes, TAN codes, voice recognition and/or other biometrical data recognition methods/devices, measures to identify first end user unit EUU1, for example using a specific unit number or code, etc.

Further, the TCW data communicated by first end user unit EUU1 can include data/information characterizing properties desired for the communications link to the second end user unit EUU2. For example, the TCW data may include data indicating a desired network (e.g., telephone/computer network of given provider A or B), technical properties of the desired communications link (data rate, communications link cost, communications link related services, etc.) and the like.

To initiate a communication with second end user unit EUU2, first end user unit EUU1 transmits (arrow 1) the TCW data to first telecommunications web site TCW1. The TCW data serve to access first telecommunications web site TCW1 such that telecommunications web site TCW1 is activated/opened for first end user unit EUU1. Further, the first TCW data include data indicating that first end user unit EUU1 desires to establish a communications link to second end user unit EUU2.

To establish a communications link, first telecommunications web site TCW1 needs information identifying second end user unit EUU2. Such information may be provided by first end user unit EUU1 in the form of a telephone number, a URL and the like. Alternatively, the information identifying second end user unit EUU2 may be the name of a user of second end user unit EUU2. In this case, first telecommunications web site TCW1 may, for example, retrieve a telephone number or URL of second end user unit EUU2 or its user from a respective data set personalized for first end user unit EUU1 or from a public telephone book.

First telecommunications web site TCW1 then selects a suitable and/or desired communications environment or network. A suitable communications environment or network may be selected by first telecommunications web site TCW1 in view of least-cost-routing, prevailing utilization, data rates, bandwidths, reliability, security, etc. A desired communications environment or network may be selected by first telecommunications web site TCW1 in view of information provided by first end user unit EUU1, for example included in the TCW data (e.g., “establish a PSTN telephone network communications link” or “establish an internet communications link”), the type of device used as or within first end user unit EUU1 (e.g., personal computer, stationary telephone, mobile telephone), the type of device usually or preferably used as or within second end user unit EUU2, contracts with the communications environment or network provider or services for first and/or end user unit EUU1, EUU2, etc.

Assuming a PSTN network or mobile network based communications link is to be established, first telecommunications web site TCW1 selects first communications link unit N1 (see FIG. 1). First communications link unit N1 may be a PSTN switching device, radio base station, or any suitable communications-enabling device. Then, data/information characterizing the selected first communications link unit N1 are communicated (see arrow 2) to first end user unit EUU1.

In response to the data/information provided by first telecommunications web site TCW1, first end user unit EUU1 contacts, via communications link 3, selected first communications link unit N1 to initiate/establish communications link 4 to second end user unit EUU2. The initiation/establishment of communications link 4 may be accomplished, for example in the case of a telephone or a computer serving as first end user unit EUU1, using a telephone number or a URL, respectively.

Communications link 5 between first end user unit EUU1 and second end user unit EUU2 is made up individual communications links 3 and 4. Since communications link 5 is established using first end user unit EUU1, first telecommunications web site TCW1 does not necessarily need data/information required to actually establish the communications link. Rather, first telecommunications web site TCW1 needs information for identifying second end user unit EUU2 in view of the selection of an appropriate communications link unit. Such information includes, e.g., the type of device of second end user unit EUU2, the geographical location of second end user unit EUU2, etc.

Independently of how the communications link 5 between first and second end user units EUU1 and EUU2 is established, costs related to establishing of the desired communications link and its use may be charged to first end user unit EUU1. Here, first end user unit EUU1 appears as a calling party with respect to first communications link unit N1. As common, communications link-related costs can be charged to the first end user unit EUU1.

In some embodiments, communications link-related costs are charged from first communications link unit N1 to first telecommunications web site TCW1, which forwards the costs to first end user unit EUU1, possibly with a service charge.

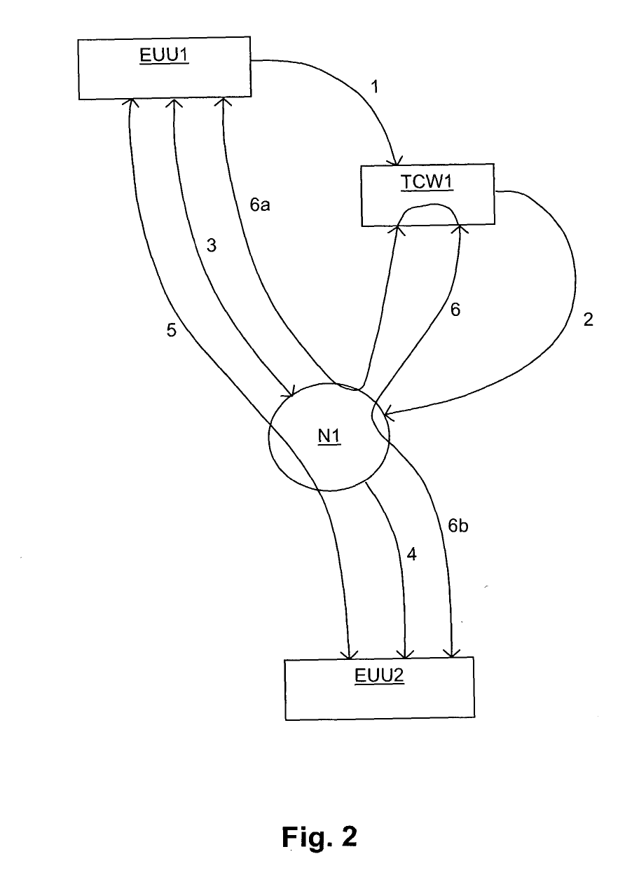

Reference may now be had to FIG. 2, which shows a schematic diagram depicting the establishment of communications link 5 or 6 between first end user unit EUU1 and second end user unit EUU2 using telecommunications web site TCW1, according to another embodiment of the present invention.

In the embodiment depicted in FIG. 2, first end user unit EUU1 desires to communicate with second end user unit EUU2. As described above with reference to FIG. 1, first end user unit EUU1 transmits (see arrow 1) TCW data to first telecommunications web site TCW1. The TCW data serve to effect an accessing of first telecommunications web site TCW1 such that first telecommunications web site TCW1 is activated/opened for first end user unit EUU1. Moreover, the TCW data include data indicating that first end user unit EUU1 desires to establish a communications link with second end user unit EUU2. Again, as discussed above with reference to FIG. 1, identification and authenticity measures may be carried out.

For establishing a communications link, first telecommunications web site TCW1 needs information characterizing second end user unit EUU2. Such information may be provided by first end user unit EUU1 in the form of a telephone number, a URL, or the name of a user of second end user unit EUU2. When a user name is provided, first telecommunications web site TCW1 may, for example, retrieve a telephone number or URL of the second end user unit EUU2 or the user from a respective data set personalized for the first end user unit EUU1 or from a public telephone book or URL register.

First telecommunications web site TCW1 then selects a suitable and/or desired communications environment or network. A suitable communications environment or network may be selected by first telecommunications web site TCW1 in view of least-cost-routing, prevailing utilization, data rates, bandwidths, reliability, security, etc. A desired communications environment or network may be selected by first telecommunications web site TCW1 in view of information provided by first end user unit EUU1, for example included in the TCW data (e.g., “establish a PSTN telephone network communications link” or “establish an internet communications link”), the type of device used as or within first end user unit EUU1 (e.g., personal computer, stationary telephone, mobile telephone), the type of device usually or preferably used as or within second end user unit EUU2, contracts with the communications environment or network provider or services for first and/or second end user unit EUU1, EUU2, etc.

Assuming a PSTN network or mobile network-based communications link is to be established, first telecommunications web site TCW1 contacts (see arrow 2) first communications link unit N1 to initiate two telephone calls originating from first communications link unit N1: one as communications link 3 to first end user unit EUU1 and one as communications link 4 to second end user unit EUU2. For establishing communications link 5 connecting first and second end user units EUU1 and EUU2, in an embodiment first communications link unit N1 merges communications links 3 and 4. Where communications links 3 and 4 are telephone communications links, this merging can be accomplished similar to a conference call. Such a communications link establishment may be performed by first communications link unit N1 by itself, for example on the basis data provided by first telecommunications web site TCW1 indicating that communications links 3 and 4 should be connected to form connecting communications link 5.

In another embodiment, communications link 6 is established between first and second end user units EUU1 and EUU2 over first telecommunications web site TCW1. In this embodiment, communications links 3 and 4 between first communications link unit N1 and first and second end user units EUU1 and EUU2, respectively, are connected via first telecommunications web site TCW1, forming communications link 6a between first end user unit EUU1 and first telecommunications web site TCW1 and communications link 6b between second end user unit EUU2 and first telecommunications web site TCW1, respectively. In this embodiment, first telecommunications web site TCW1 can be considered as a party calling both first end user unit EUU1 and second end user unit EUU2 via first communications link unit N1, with first telecommunications web site TCW1 effecting communications link 6.

Independently of how communications link 5 or 6 between first and second end user units EUU1 and EUU2 is established, costs related to the establishing of the communications link and its use may be charged to first end user unit EUU1. Here, first telecommunications web site TCW1 appears as a calling party with respect to first communications link unit N1. Commonly, communications link-related costs are charged to the calling party. According to the present invention, costs charged to first telecommunications web site TCW1 may be forwarded to first end user unit EUU1, possibly with additional service charges.

In some embodiments, communications link-related costs are directly charged from first communications link unit N1 to first end user unit EUU1. This may be accomplished in response to respective data provided by first telecommunications web site TCW 1, similar to an R-call known from telephone networks.

The embodiments described with respect to FIG. 2 enable call-by-call service to be provided for end user units (e.g., mobile telephones) for which no call-by-call service is typically provided, using a so-called call-back service. For a call-back service, first telecommunications web site TCW1 obtains, in response to an access by first end user unit EUU1, data identifying second end user unit EUU2 and indicating that a communications link to end user unit EUU2 is desired. Then, first telecommunications web site TCW1 terminates the communications link established from first end user unit EUU1 to first telecommunications web site TCW1, e.g., by terminating a “#0800-service” call from first end user unit EUU1. Thus, costs related to the communications link initially established from the first end user unit EUU1 to the first telecommunications web site TCW1 can be significantly reduced.

In another embodiment, first telecommunications web site TCW1 is contacted by first end user unit EUU1 but refuses an establishment of a communications link to first end user unit EUU1 (comparable to the situation where the handset of a regular telephone is not picked up in response to an incoming telephone call). Then, first telecommunications web site TCW1 obtains, without an establishment of a communications link between the first end user unit EUU1 and the first telecommunications web site TCW1, data identifying second end user unit EUU2. In this way, communications link costs related to a communications link between first end user unit EUU1 and telecommunications web site TCW1 may be avoided.

Where first telecommunications web site TCW1 has access to data identifying both first end user unit EUU1 and second end user unit EUU2, the first telecommunications web site TCW1 can use this information to establish communications links 3 and 4 to first and second end user units EUU1 and EUU2, respectively, as described above.

In an embodiment, first telecommunications web site TCW1 contacts second end user unit EUU2 first and first end user unit EUU1 subsequently, advantageously with little or no waiting time for second end user unit EUU2. Then, first and second end user units EUU1 and EUU2 are connected to each other. If second end user unit EUU2 cannot be reached or refuses an establishment of a communications link with first end user unit EUU1, first end user unit EUU1 can be informed correspondingly, e.g., using a short message service (SMS) message. Such information can also include an option for first end user unit EUU1 to instruct first telecommunications web site TCW1 to later make another attempt to establish a communications link to second end user unit EUU2.

In another embodiment, first telecommunications web site TCW1 connects to first end user unit EUU1 first and connects to second end user unit EUU2 subsequently. Connection 6b to second end user unit EUU2 can be initiated upon first end user unit EUU1 accepting communications link 6a between first telecommunications web site TCW1 and first end user unit EUU1. Again, information can be provided to first end user unit EUU1, e.g., in form of an SMS message, when second end user unit EUU2 cannot be reached or refuses an establishment of a communications link with first end user unit EUU1.

In an embodiment, second end user unit EUU2 or an associated user may be informed that first end user unit EUU1 unsuccessfully tried to establish a communications link to second end user unit EUU2. This informing may be by, e.g., an SMS message to second EUU2 or another end user unit associated with the user of second end user unit EUU2.

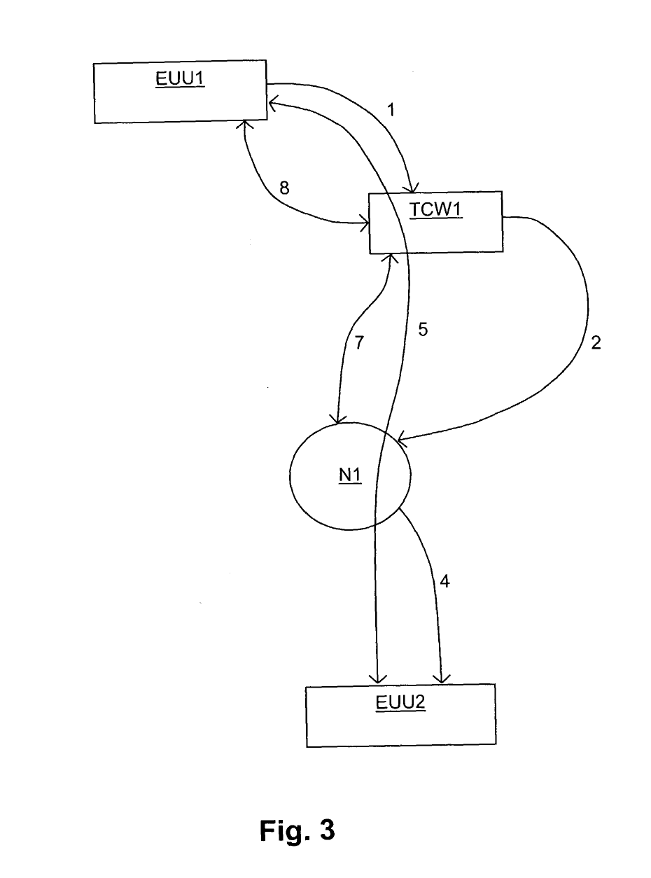

FIG. 3 shows a schematic diagram depicting the establishment of communications link 5 between first end user unit EUU1 and second end user unit EUU2 using telecommunications web site TCW1. As described with respect to FIG. 2, first end user unit EUU1 provides TCW data to telecommunications web site TCW1 (see arrow 1), telecommunications web site TCW1 contacts first communications link unit N1 (see arrow 2), and first communications link unit N1 establishes communications link 4 to second end user unit EUU2. The embodiment shown in FIG. 3 differs from the embodiment shown in FIG. 2 in that no communications link directly from first communications link unit N1 to first end user unit EUU1 is established. Rather, communications to and from first end user unit EUU1 up to first communications link unit N1 are executed via first telecommunications web site TCW1.

Here, communications link 5 between first end user unit EUU1 and second end user unit EUU2 is achieved via communications link 7 between first telecommunications web site TCW1 and first communications link unit N1, communications link 8 between first end user unit EUU1 and first telecommunications web site TCW1, and communications link 4 between second end user unit EUU2 and first communications link unit N1. Communications link 8 can be the same as communications link 1 used by first end user unit EUU1 for accessing first telecommunications web site TCW1 or, as illustrated, may be another communications link originating from first telecommunications web site TCW1 to first end user unit EUU1.

In this embodiment, billing of communications link costs to first end user unit EUU1 will be carried out under control of first telecommunications web site TCW1.

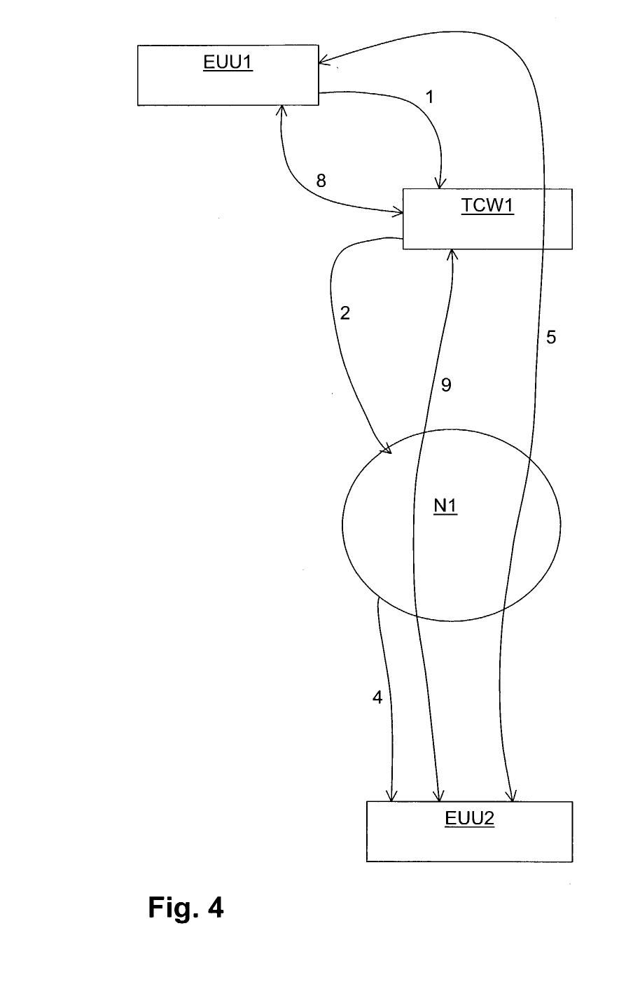

FIG. 4 shows a schematic diagram depicting the establishment of communications link 5 between first end user unit EUU1 and second end user unit EUU2 using telecommunications web site TCW1 according to another embodiment of the present invention. In the embodiment shown in FIG. 4, communications link 5, used for a communications between the two end user units, is established via first telecommunications web site TCW1. First telecommunications web site TCW1 contacts, in response to TCW data from first end user unit EUU1, second end user unit EUU2 via first communications link unit N1. As described above with reference to FIG. 3, first end user unit EUU1 provides TCW data to telecommunications web site TCW1 (see arrow 1), telecommunications web site TCW1 contacts first communications link unit N1 (see arrow 2), and first communications link unit N1 establishes communications link 4 to second end user unit EUU2.

In this embodiment, contacting second end user unit EUU2 by first telecommunications web site TCW1 does not necessarily include establishment of a communications link by first telecommunications web site TCW1 to second end user unit EUU2. Rather, here it is sufficient for first telecommunications web site TCW1 to provide second end user unit EUU2 information characterizing first end user unit EUU1 and/or the telecommunications web site associated with EUU1, i.e., first telecommunications web site TCW1. Then, upon contact from first telecommunications web site TCW1 via communications unit N1, second end user unit EUU2 contacts first telecommunications web site TCW1 over communications link 9, established via communications unit N1, on the basis of respective characterizing data. Such characterizing data may include data uniquely characterizing first telecommunications web site TCW1, via which the intended communications link to first end user unit EUU1 may be established. Further, such characterizing data may include data uniquely characterizing first end user unit EUU1. Thereby first telecommunications web site TCW1 may be contacted, e.g., using a so-called communications link forwarding. According to the communications link forwarding, communications links to be established to first end user unit EUU1 are routed or redirected to first telecommunications web site TCW1. Then, first telecommunications web site TCW1 will forward incoming communications links to a destination defined by first end user unit EUU1, here first end user unit EUU1 itself.

To form communications link 5, communications link 9 between second end user unit EUU2 and first telecommunications web site TCW1 is continued to first end user unit EUU1 via communications link 8 between the first end user unit EUU1 and the first telecommunications web site TCW1. Communications link 5 is established via communications unit N1, as shown. In other embodiments, communications link 5 is established via another communications unit, which in certain embodiments resides in a different network than communications unit N1. Communications link 8 can be a link used by first end user unit EUU1 to access first telecommunications web site TCW1 (see arrow 1) or another link.

First telecommunications web site TCW1 is associated with first end user unit EUU1 and in some embodiments accesses of first telecommunications web site TCW1 only by first end user unit EUU1 may be permitted. Therefore, first telecommunications web site TCW1 may be operated such that upon the above-described contact by second end user unit EUU2 no access occurs. First telecommunications web site TCW1 thereby serves similar to a network node connecting different parties. In certain embodiments, for communications links as shown in FIG. 4, an access of first telecommunications web site TCW1 by second end user unit EUU2 is allowed. This access may be time-restricted and controlled by first telecommunications web site TCW1 automatically.

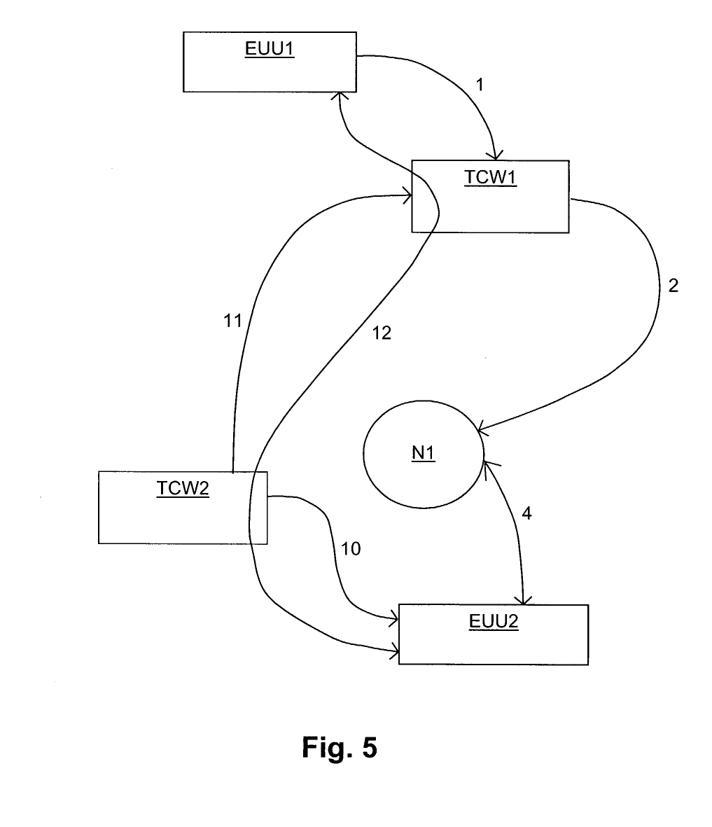

FIG. 5 shows a schematic diagram depicting the establishment of communications link 12 between first end user unit EUU1 and second end user unit EUU2 using telecommunications web site TCW1 according to another embodiment of the present invention. In this embodiment again, as described above with reference to FIG. 4, first end user unit EUU1 provides TCW data to telecommunications web site TCW1 (see arrow 1), telecommunications web site TCW1 contacts first communications link unit N1 (see arrow 2), and first communications link unit N1 establishes communications link 4 to second end user unit EUU2.

In the embodiment shown in FIG. 5, however, upon establishing communications link 4 from first communications link unit N1 to second end user unit EUU2, second end user unit EUU2 accesses second telecommunications web site TCW2 (see arrow 10), which is associated with second end user unit EUU2. In order to inform telecommunications web site TCW2 that a communications link is to be established between first end user unit EUU1 and second end user unit EUU2, second end user unit EUU2 communicates TCW data to second telecommunications web site TCW2. This TCW data may include data/information required to allow an access of second telecommunications web site TCW2 by second end user unit EUU2 and data/information required by second telecommunications web site TCW2 to at least initiate an establishment of a desired communications link.

Data/information for accessing second telecommunications web site TCW2 include data characterizing second telecommunications web site TCW2 and may include, for security reasons, data identifying second end user unit EUU2 as an authorized user and/or authorizing second end user unit EUU2 or its user to access second telecommunications web site TCW2.

Data/information suitable for security purposes include so-called caller recognition of a user of second end user unit EUU2, for example PIN codes, TAN codes, voice recognition and/or other biometrical data recognition methods/devices, measures to identify second end user unit EUU2, for example using a specific unit number or code, etc.

Further, the TCW data communicated by second end user unit EUU2 may include data/information characterizing properties desired for the communications link to the second end user unit EUU2. For example, the TCW data may include data indicating a desired network (e.g., telephone/computer network of given provider A or B), technical properties of the desired communications link (data rate, communications link cost, communications link related services, etc.) and the like.

In response to the TCW data from second end user unit EUU2, second telecommunications web site TCW2 contacts first telecommunications web site TCW1 (see arrow 11) such that communications link 12 between second end user unit EUU2 and first end user unit EUU1 is established via second telecommunications web site TCW2 and first telecommunications web site TCW1. The portion of communication link 12 between second end user unit EUU2 and second telecommunications web site TCW2 may be a link used by second end user unit EUU2 to access second telecommunications web site TCW2 (see arrow 10) or another link. Moreover, the portion of communications link 12 between first end user unit EUU1 and first telecommunications web site TCW1 may be a link used by first end user unit EUU1 to access first telecommunications web site TCW1 (see arrow 1) or another link, as described above with reference to FIG. 4.

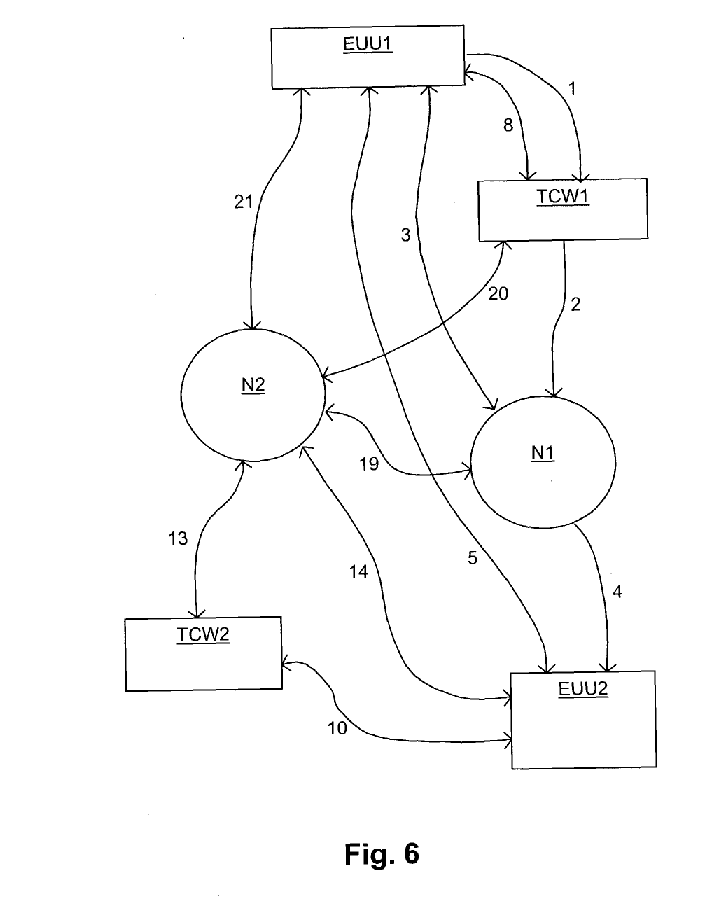

FIG. 6 shows a schematic diagram depicting the establishment of communications link 5 between first end user unit EUU1 and second end user unit EUU2 according to another embodiment of the present invention. Here, second telecommunications web site TCW2 associated with second end user unit EUU2 connects to second communications link unit N2 (see arrow 13).

Communications link 14 between second communications link unit N2 and second end user unit EUU2 may be established by second end user unit EUU2 contacting second communications link unit N2 in response to data/information provided by second telecommunications web site TCW2, similar to the manner in which communication link 3 between first end user unit EUU1 and first communications link unit N1 is established as described above with reference to FIG. 1. Alternatively, communications link 14 may be established by second telecommunications web site TCW2 contacting second communications link unit N2 to initiate a telephone call from second communications link unit N2 as communications link 13, similar to the manner in which communications link 3 is established as described above with reference to FIG. 2.

Communications link 21 between second communications link unit N2 and first end user unit EUU1 may be established analogously to the establishment of communications link 4 between first communications link unit N1 and second end user unit EUU2.

Depending on the particular embodiment, communications link 5 between first end user unit EUU1 and second end user unit EUU2 may traverse all or some of first telecommunications web site TCW1, first communications link unit N1, second communications link unit N2, and second telecommunications web site TCW2, and include corresponding interconnecting intermediate links. For simplicity, communications link 5 is depicted in FIG. 5 directly connecting first end user unit EUU1 with second end user unit EUU2.

In the embodiments described herein, a so-called reverse charging option may be provided. Reverse charging option refers, as used herein, to charging communications link-related costs to a called party, e.g., to second end user unit EUU2 in the embodiments described above. Consequently, the charging/billing measures described with respect to first end user unit EUU1 are carried out with respect to second end user unit EUU2. The reverse charging option may require an acceptance by second end user unit EUU2 that costs related to a communications link between first and second end user units EUU1 and EUU2 are charged to second end user unit EUU2.

In the embodiments described with reference to FIGS. 1-5, first end user unit EUU1 and/or first telecommunications web site TCW1 determine the communications link to be established to second end user unit EUU2. In those embodiments, when second end user unit EUU2 has accepted a reverse charging it also accepts the communications link and its related costs. In the embodiment shown in FIG. 6, in contrast, assuming second end user unit EUU2 accepts a reverse charging, second end user unit EUU2 and/or associated second telecommunications web site TCW2 can select, determine, and establish a communications link used for communications with first end user unit EUU1. Second end user unit EUU2 as the called party is thereby enabled to, at least partially, control costs related to communications with a calling party, here first end user unit EUU1.

It should be noted that features described herein for specific embodiments may be integrated in different embodiments, i.e., a feature of a particular embodiment may be implemented in another embodiment. Moreover, although communications links between two end user units are described, communications links between more than two end user units, e.g., three, four, ten, etc, end user units are within the scope of the present invention. For example, a “calling” end user unit can communicate with two “called” end user units by respective communications links each established as described above.

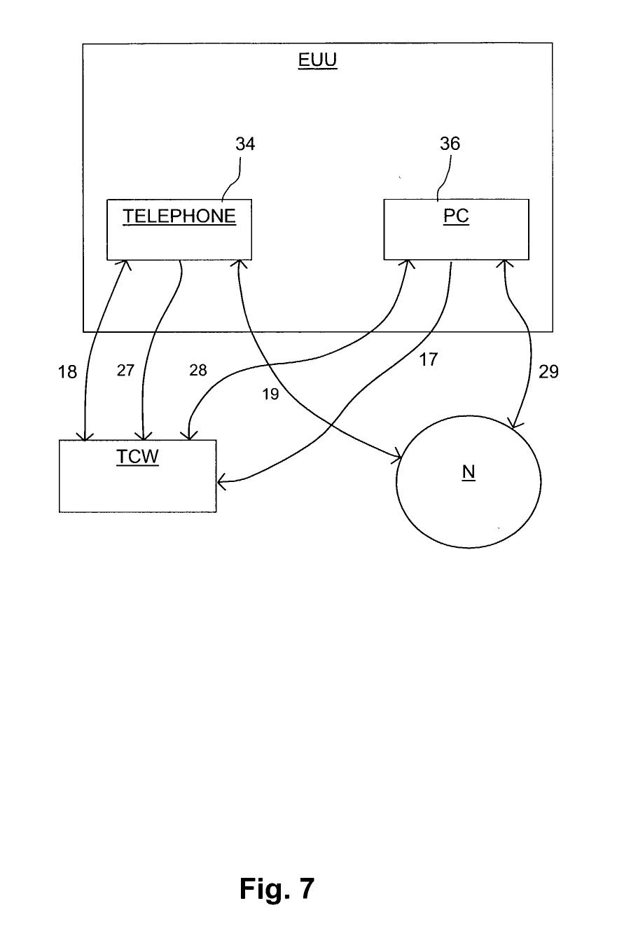

An end user unit may be a single device or system, or a combination of separate devices, as illustrated in FIG. 7.

Referring to FIG. 7, end user unit EUU includes telephone 34 and personal computer 36. Both telephone 34 and personal computer 36 can independently serve as first or second end user unit EUU1, EUU2 in the embodiments described above with reference to FIGS. 1-6, or can be employed in combination. For example, personal computer 36 can be used to contact (see arrow 17) associated telecommunications web site TCW, while telephone 34 may be employed for communicating via established communications link 18 through telecommunications web site TCW or communications link 19 through communications link unit N. Of course, instead telephone 34 may be used to contact (see arrow 27) associated telecommunications web site TCW, while personal computer 36 may be employed for communicating via established communications link 28 through telecommunications web site TCW or communications link 29 through communications link unit N.

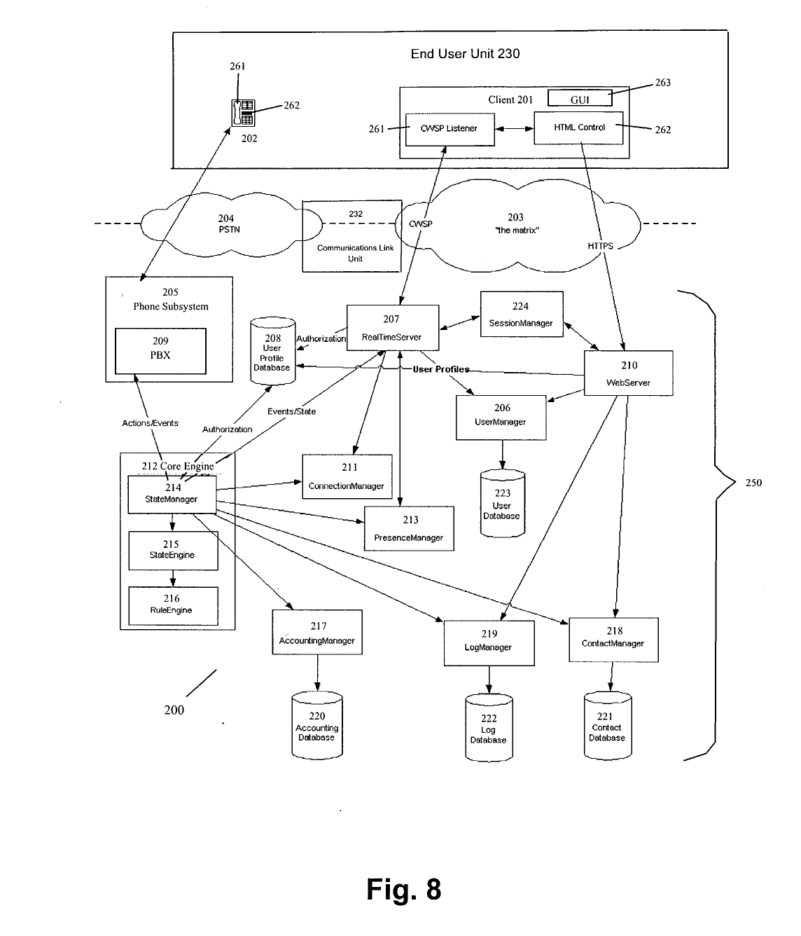

FIG. 8 shows the architecture of a communications environment 200 according to an embodiment of the present invention. Communications environment 200 includes telecommunications web site 250 and client 201, which communicate over matrix 203. Matrix 203 may be the Internet or an intranet, for example. Client 201 and telephone 202 are part of end user unit 230. Telephone 202 communicates with telecommunications web site 250 over PSTN 204 to access phone subsystem 205. Telephone 202 may belong to the specific entity, i.e., the owner of telecommunications web site 250. Telephone 202 includes handset 261, which serves as an interface for user input and output, i.e., voice signals. Other telephones may serve as end user units for other called parties and/or users of telecommunications web site 250 and may likewise communicate over PSTN 204 and access phone subsystem 205. Network interface device 262 is also included in telephone 202 for interfacing with PSTN 204. In other embodiments of the present invention, other types of end user units which access telecommunications web site 250 over other types of networks or communications links may be provided.

Communications link unit 232 may be a PSTN switching device, mobile phone network, UMTS network, radio base station, or any suitable communications-enabling device. The communication link unit 232 is controlled by signals from an external network.

Client 201 provides a user interface for a user accessing telecommunications web site 250. The user may be any authorized user of telecommunications web site 250, including the specific entity. In an embodiment client 201 resides on a computing device of a user. In other embodiments client 201 may reside on other types of user communications devices. Where the user computing device is personal computer, client 201 may be a browser with a combination of, e.g., HTML code, Active-X components, JavaScript and/or an Java Applet. In another embodiment, client 201 is a stand-alone application. Using Active-X, Java or a stand-alone application enables active signaling to the client. A browser is only able to support “pull”-functionality, while an application supporting “push” functionality like “signaling that there is an incoming call” needs to be active listening on a communication port. Where the user computing device is a mobile phone or PDA client 201 may be implemented using, e.g., Java2 Micro Edition or Windows CE. For other user communication devices client 201 may be implemented using any language provided to develop applications for these devices. More than one client 201 may be provided, each one corresponding to a given user. Client 201 includes CWSP listener module 261, HTML control module 262, and graphical user interface (GUI) 263. GUI 263 may be a browser-based graphical user interface including action buttons for clicking to perform actions. CWSP listener module 261 is a module that signals events (e.g., incoming call, new e-mail message, new fax, new visitor, etc.) to client 201. In an embodiment, the novel client-server signaling protocol described in the commonly-owned U.S. patent application entitled “Signaling Protocol,” attorney docket number 5007.1016, filed Mar. 24, 2003, and which is hereby incorporated by reference herein, is used for communication between CWSP listener module 261 and real time server 207 (described below) of telecommunications web site 250. This novel signaling protocol, which will herein after be referred to as “signaling protocol CWSP,” provides for encryption (TLS 1.0/SSL 3.0) of datagrams with asymmetric handshake and symmetric session encryption, with no need for certificates from client 201. Signaling protocol CWSP provides for signaling of the following:

Login Handshake

Signalling of Line States with unique LINE-Ids, including ringing and hang-up

Initiate Line Actions, including call number and route incoming call to a number

Client State, including represent the general state of the application and signal the refresh of certain areas on the client

Keep-Alive

Logout

Time-Sync

Packet-Delay measurement to ensure fast data rate

Presence Information of contacts (Logon/Logoff/Break/ . . . ).

HTML control module 262 controls specific areas of the user interface and loads HTML pages into any controlled area on request by CWSP listener module 261. HTML control module 262 communicates with web server 210 (described below) of telecommunications web site 250. In an embodiment, HTML control module 262 is Microsoft Internet Explorer. Alternatively, HTML control module may be any other browser instance, such as Netscape Navigator or any other implementation of a browser. To ensure privacy of the communications between HTML control module 262 and web server 210, HTML control module 262 uses the protocol Hypertext Transfer Protocol over TLS (HTTPS), which is described in E. Rescorla, Memo, Network Working Group, “HTTPS Over TLS”, The Internet Society, 2000, which is hereby incorporated by reference herein.

Telecommunications web site 250 may includes a variety of components: phone subsystem 205, user manager 206, real time server 207, user profile database 208, web server 210, connection manager 211, core engine 212, presence manager 213, account manager 217, contact manager 218, log manager 219, and session manager 224. Some or all of the components of telecommunications web site 250 may be software components running on any of a variety of operating systems, such as any flavour of UNIX (BSD, Solaris, HP-UX, etc.), Linux, any Microsoft operating system (DOS, Windows 95, 98, NT, XP, ME, etc.), and any real time operating system (e.g., QNX, RTOS, EUROS, etc.), for example. Some or all of the components of telecommunications web site 250 may run on any of a variety of known or future computer hardware (e.g., Intel, AMD, HP, Sun, Motorola, IBM, etc.). Some or all of the components of telecommunications web site 250 may be written in any of a variety of programming language, preferably any higher programming language such as C, Fortran, Basic, Pascal, Lisp, etc., or any higher object oriented programming language such as C++, Java, Python, etc., or any script language like Perl, PHP, etc., for example. Some or all of the components of telecommunications web site 250 may reside on the same hardware and may communicate via any suitable interprocess communication method provided by the operating system.

When any component of telecommunications web site 250 communicates with any other component not residing on the same hardware, the relevant components may use any of a variety of network communication protocols, such as, for example, Common Object Request Broker Architecture (CORBA), Remote Procedure Calls (RPC), Simple Object Access Protocol (SOAP), RPC via SOAP, HTTP, FTP, etc. Communication between components of telecommunications web site 250 may be established via mounting of file systems and exchange of files. Some or all of the components of telecommunications web site 250 may exist in parallel multiple times so as to provide a scalable system for many, even several million users or more. In some embodiments of the present invention, several instances of the same component may be distributed on several different hardware devices. Hardware links between different hardware devices may be any of a variety of communications links, such as Ethernet, for example, or other network types, using any of a variety of interfaces, such as serial, parallel, etc.

Database components, such as user profile database 208, contact database 221 (discussed below), accounting database 220 (discussed below), log database 222 (discussed below), and user database 223 (discussed below), may be any of a variety of relational databases, such as ORACLE, mySQL, etc., or object oriented databases, such as ‘Fast Objects’, any OQL database, XML Databases like dbXML, Tamino, X-Hive/DB, etc.

Phone subsystem 205 incorporates one or more private branch exchanges (PBX) 209. PBX 209 may include, for example, the Net@tec Phone Subsystem with NMS hardware, made by Net@tec. Phone subsystem 205, using PBX 209, may provide the following functionality:

Signalling of incoming calls

Signalling of Phone Events (e.g., Ringing, Hang-up, Connect)

Signalling of DTFM

Creation of new Line Handles

Connection of 2 or more Line Handles for conferencing

Forwarding of incoming calls

User manager 206 receives login and password information and returns the corresponding user identification number if the combination is correct. In an embodiment, user manager 206 is a CORBA service providing functions for checking combinations of login name and password for their correctness. Alternatively, user manager 206 may be a service of another suitable protocol. User manager 206 communicates with user database 223 to check the login and password information and to locate the correct user identification number. User database 223 stores central user data, such as login, password and address information, for each user.

Real time server 207 is in one embodiment a CORBA service and a CORBA client with a CWSP listener interface so as to be able to communicate with clients 201 via signaling protocol CWSP and with other components of telecommunications web site 250 described below. Alternatively, real time server 207 may be a service and a client of another suitable protocol. Real time server 207 may reside on any suitable server hardware running on any suitable operating system In an embodiment, real time server 207 performs the following functions:

Sends all signals representing the current state of the system via signalling protocol CWSP to client 201.

Uses session manager 224 to share a session with web server 210. This ensures that the right combination of information is sent from real time server 207 and web server 210 to client 201. This ensures that no other user is able to access data of any other user.

Uses user profile database 208 to check the authorization level of a user. This is required because different users may have different contracts enabling them to use a different set of features of telecommunications web site 250.

Uses connection manager 224 to keep track of the lines (connections between phone subsystem 205 and any telephone) and logins of a given user. At any time the connection manager will know which lines on which PBX 209 and which logons on which instances of real time server 207 belong to a given user.

Uses presence manager 213 to keep track of the presence condition of any user.

Signals events to core engine 212 (e.g., the “call telephone number 00497219432940 button” was pressed on client 201), and receives information about the current state of the system from the core engine.

User profile database 208 holds user profiles containing information about the subscriber contract type, the user's telephones, personal settings and personal rules, invoices, permissions and the personal state graphs that describe the behavior of the system at any given time.

Web server 210 provides all information displayed on client 201 which is not being transported by signaling protocol CWSP. In an embodiment, web server 210 is an Apache web server with the proper set of HTML pages and Scripting functionality for creating dynamic and personalized web pages using data retrieved from the other components via, e.g., IIOP (CORBA) or other suitable protocol. Alternatively, web server 210 may be an MS-IIS web server or any other suitable web server. In an embodiment, web server 210 provides the following functions:

Creates a Client Home Page with the personal greeting text, which is displayed using client 201.

Receives personal text messages from visitors of telecommunications web site 250 and organizes delivery of these messages to the owner of telecommunications web site 250, i.e., the specific entity.

Talks to user profile database 208 to display or to set the personal settings and personal texts.

Uses log manager 219 to create individual pages of personal log data. Log data is a record of all communication (incoming and outgoing) via telecommunications web site 250. Pages are subsets of this record (e.g., all emails, all communication to a specific contact) sorted by any criteria (date, subject, etc.)

Uses contact manger 216 to create individual lists of contacts and to store new contacts created on client 201.

Connection manager 211 enables the ability to get a connection between logons and current ongoing calls for a given user at a given time. In an embodiment, connection manager 211 is a CORBA service providing the functions described below. Alternatively, connection manager 211 may be a service of another suitable protocol. Connection manager 211 may reside on any of a variety of hardware, e.g., INTEL-based or AMD-based with any of a variety of operating systems, e.g., Linux or MS-Windows. For the user, or specific entity, there are several ways to get into contact with telecommunications web site 250. One of these ways is using client 201 on, e.g., a personal computer. To authorize his access, the specific entity types in his username and password and is then granted access to the telecommunications web site with certain privileges. This is called “logon”. The specific entity may be logged on from different systems at the same time. For an incoming telephone call to the specific entity's telecommunications web site phone number, core engine 212 can access from connection manager 211 which system and with which address(es) the specific entity is logged on. This capability is advantageous for visualizing, on client 201, the current state (logons, connection details, etc.) of telecommunications web site 250. In an embodiment, connection manager 211 provides the following functionality:

Holds accounts of all logons and the associated real time server(s). Depending on the size of telecommunications web site 250, more than one real time server may be provided. A logon may be associated with a particular real time server.

Holds accounts of all ongoing calls and associated core engine(s). Depending on the size of telecommunications web site 250, more than one core engine may be provided. An ongoing call may be associated with a particular core engine.

It provides functions to find all real time server sessions and all core engines belonging to a specific entity.

Core engine 212 is a central component of telecommunications web site 250, and controls the current states of the telecommunications web site, and includes state manager 214, state engine 215 and rule engine 216. In an embodiment, core engine 212 is a CORBA service and CORBA client providing the functions described below. Alternatively, core engine 212 may be a service and client of another suitable protocol. Core engine 212 may reside on any of a variety of hardware, e.g., INTEL-based or AMD-based with any of a variety of operating systems, e.g., Linux or MS-Windows. In an embodiment, core engine 212 provides the following functions:

a Uses several state managers 214 to communicate with user manager 206, real time server 207, user profile database 208, PBX 209, connection manager 211, presence manager 213, account manager 217, contact manager 218, and log manager 219.

Uses real time server 207 to signal events and the current state of the system to client 201; receives events from real time server 207.

Uses user profile database 208 to authorize calls and to retrieve user profile data for, for example, call forwarding functionality, time based change of profiles, checking of permissions, etc.

Uses phone subsystem 205 to initiate calls and conferences; and receives signals from phone subsystem 205 about incoming calls, hang-ups, DTFMs, etc.

Uses connection manager 211 to store information about current calls and to determine the respective real time server 207 instance to signal the state of each current call to.

Uses presence manager 213 to store current presence information for each user.

Uses accounting manager 217 to write call data records for accounting.

Uses contact manager 218 to identify calling numbers as known contacts. Depending on this identification the forwarding might be different. The specific entity can set profiles defining, for example, that a call from user A should always be forwarded to the secretary, while a call from user B should be forwarded to his mobile phone, if the call is within normal business hours. Thus, the reaction of telecommunications web site 250 can depend on the caller, etc.

Uses log manager 219 to write personal log records of calls.

Presence manager 213 is responsible for tracking the current presence status (offline, online, reachable, in break, in conference, etc.) of users. In an embodiment, presence manager 213 is a CORBA service providing the functions described below. Alternatively, presence manager 213 may be a service of another suitable protocol. Presence manager 213 may reside on any of a variety of hardware, e.g., INTEL-based or AMD-based with any of a variety of operating systems, e.g., Linux or MS-Windows. In an embodiment, presence manager 213 provides the following functionality:

Stores current presence information as set by real time server 207 and core engine 212.

Delivers the current presence information to real time server 207 and core engine 212.

State manager 214 of core engine 212 serves as the communicating part of core engine 212. State manager 214 is a subsystem of the core engine 212 and in an embodiment is a CORBA service providing the functions described below. Alternatively, state manager 214 may be a service of another suitable protocol. State manager 214 may reside on any of a variety of hardware, e.g., INTEL-based or AMD-based with any of a variety of operating systems, e.g., Linux or MS-Windows. In an embodiment of the present invention, state manager 214 may serve as a CORBA client and/or CORBA server for one or more of real time server 207, user profile database 208, PBX 209, connection manager 211, presence manager 213, account manager 217, contact manager 218, and log manager 219. In an embodiment, state manager 214 provides the following functionality:

Represents the current state of the system for real time server 207, user profile database 208, PBX 209, connection manager 211, presence manager 213, account manager 217, contact manager 218, and log manager 219.

Passes necessary information to state engine 215. For example, loads a user state graph from profile database 208 and passes the graph onto state engine 215.

Receives information from state engine 215 and initiates the appropriate calls of functions of real time server 207, user profile database 208, connection manager 211, presence manager 213, account manager 217, contact manager 218, and log manager 219.

State engine 215 uses the user state graph from user profile database 208 to move from one state to another; and executes the defined rules and triggers the appropriate actions, or events, via state manager 214. State engine 215 uses rule engine 216 to evaluate rules defined by the user, which are relevant to the current state. This evaluation process results in the next move by state engine 215 on the user state graph. State engine 215 thus provides a way to move on a user state graph and to control the behavior of telecommunications web site 250 according to the rules. In an embodiment, state engine 215 is software written in the C++ programming language. Alternatively, state engine 215 may be software written in any of a variety of other higher programming languages. State engine 215 may reside on any of a variety of hardware, e.g., INTEL-based or AMD-based with any of a variety of operating systems, e.g., Linux or MS-Windows.

Rule engine 216 provides evaluation of user defined rules stored in user profile database 208, including checking preconditions and deciding whether or not the rule must be applied. These rules provide actions associated with respective conditions. The specific entity can set profiles defining, for example, that a call from user A should always be forwarded to the secretary, while a call from user B should be forwarded to his mobile phone, if the call is within normal business hours. Thus, the reaction of telecommunications web site 250 can depend on the caller, etc. In an embodiment, rule engine 216 is software written in the C++ programming language. Alternatively, rule engine 216 may be software written in any of a variety of other higher programming languages. Rule engine 216 may reside on any of a variety of hardware, e.g., INTEL-based or AMD-based with any of a variety of operating systems, e.g., Linux or MS-Windows.

Accounting manager 217 receives accounting-relevant information, e.g., call data, records from state manager 214 which were created in state engine 215. In order to perform these tasks, accounting manager 217 provides an interface, e.g., CORBA, with functions to write and read accounting information. These call data records are then written into accounting database 220 for future processing, such as for billing purposes. In an embodiment, accounting manager 217 is software written in the C++ programming language. Alternatively, accounting manager 217 may be software written in any of a variety of other higher programming languages. Accounting manager 217 may reside on any of a variety of hardware, e.g., INTEL-based or AMD-based with any of a variety of operating systems, e.g., Linux or MS-Windows.

Contact manager 218 stores user contact data in contact database 221. User contact data may include, for example, title, first and last name, sex, date of birth, phone numbers, fax numbers, postal addresses, email addresses, etc. In an embodiment, contact manager 218 is a CORBA service that provides an interface with functions to store, retrieve, change and delete contact information. Alternatively, contact manager 218 may be a service of another suitable protocol. Contact manager 218 serves as an interface for storage and retrieval by web server 210, and retrieval by core engine 212, of contact data. In an embodiment, contact manager 218 is software written in the C++ programming language. Alternatively, contact manager 218 may be software written in any of a variety of other higher programming languages. Contact manager 218 may reside on any of a variety of hardware, e.g., INTEL-based or AMD-based with any of a variety of operating systems, e.g., Linux or MS-Windows.

Log manager 219 stores user log data in log database 222. User log data are records of communications of a given user, e.g.: “3.3.2002 17:01 Call from Frank—Duration 1:23”, “3.3.2002 17:15 Email to Frank—Size 69.345 Bytes”. In an embodiment, log manager 219 is a CORBA service that provides an interface with functions to store, retrieve, change and delete user log data. Alternatively, log manager 219 may be a service of another suitable protocol. In an embodiment, log manager 219 is software written in the C++ programming language. Alternatively, log manager 219 may be software written in any of a variety of other higher programming languages. Log manager 219 may reside on any of a variety of hardware, e.g., INTEL-based or AMD-based with any of a variety of operating systems, e.g., Linux or MS-Windows. In an embodiment, log manager 219 provides the following functionality:

Receives log data from core engine 212.

Answers requests for user log data from web server 210, returning the data in specifically filtered or sorted formats. An example of such a user log data request is a request for all calls from a special user within the last 2 months.

Allows certain requests from web server 210 to delete specific log data.

Allows certain requests from web server 210 to add documents to specific log data entries. Examples of such documents include a note about a given phone call, documents exchanged during a given phone call, etc.

Session manager 224 creates and stores a record of each user session. In an embodiment, session manager 224 is a CORBA service that provides an interface with functions to open, close and check a session. Alternatively, session manager 224 may be a service of another suitable protocol. In an embodiment, session manager 224 is software written in the C++ programming language. Alternatively, session manager 224 may be software written in any of a variety of other higher programming languages. Session manager 224 may reside on any of a variety of hardware, e.g., INTEL-based or AMD-based with any of a variety of operating systems, e.g., Linux or MS-Windows. In an embodiment, session manager 224 provides the following functionality:

Upon login via real time server 207 or via web server 210, creates a session and an associated unique session token. Since messages from client 201 to real time server 207 and web server 210 need a valid session token in order to be executed, real time server 207 and web server 210 check each request for the session token and request validation from session server 207.

Deletes a session after a defined time of inactivity.

It should be noted that telecommunications web site 250 is scaleable. Some or all of the above-described components may be duplicated several times, depending on the number of users and size of telecommunications web site 250.

The functioning of communications environment 200 will now be demonstrated by way of examples.

### EXAMPLE 1

FIGS. 1 and 8 may be used to demonstrate establishment of communications link 5 between first end user unit EUU1 and second end user unit EUU2 using first telecommunications web site TCW1. End user unit EUU1 may be employed by a specific entity associated with first telecommunications web site TCW1. End user unit EUU1 desires to establish communications with end user unit EUU2. Telecommunications web site 250 in FIG. 8 corresponds to first telecommunications web site TCW1 in FIG. 1. End user unit 230 and communications link unit 232 in FIG. 8 correspond to end user unit EUU1 and communications link unit N1, respectively, in FIG. 1.

Assumed initiate state of communications environment 200 is as follows: No ongoing calls; no precall (i.e., no call from an end user unit of specific entity SE to telecommunications web site 250 where the telecommunications web site does not yet know where to forward the call, pending, for example the specific entity selecting a calling destination on client 201); specific entity SE is logged on to telecommunications web site 250 with client 201. The chain of events in communications environment 200 is as follows:

1. Telephone 202 contacts phone subsystem 205 via PSTN 204 by sending information identifying end user unit EUU2.

2. Private branch extension 209 signals the information to state engine 215 via state manager 214.

3. State engine 215 loads the user state graph from user profile database 208 via state manager 214 and requests detailed user information from the user of end user unit EUU2.

4. State engine 215 filters the requested information and sends it via state manager 214, phone subsystem 205 and PSTN 204 back to telephone 202.

5. Telephone 202 uses the received information to signal communications link unit N1 to connect to end user unit EUU2.

6. If end user unit EUU2 accepts the connection, communications link unit N1 creates communication link 5.

### EXAMPLE 2

FIGS. 2 and 8 may be used to demonstrate establishment of communications link 5 or 6 between first end user unit EUU1 and second end user unit EUU2 using first telecommunications web site TCW1. End user unit EUU1 may be employed by a specific entity associated with first telecommunications web site TCW1. End user unit EUU1 desires to establish communications with end user unit EUU2. Telecommunications web site 250 in FIG. 8 corresponds to first telecommunications web site TCW1 in FIG. 2. End user unit 230 and communications link unit 232 in FIG. 8 correspond to end user unit EUU1 and communications link unit N1, respectively, in FIG. 2.

Assumed initiate state of communications environment 200 is as follows: No ongoing calls; no precall (i.e., no call from an end user unit of specific entity SE to telecommunications web site 250 where the telecommunications web site does not yet know where to forward the call, pending, for example the specific entity selecting a calling destination on client 201); specific entity SE is logged on to telecommunications web site 250 with client 201. The chain of events in communications environment 200 is as follows:

1. Telephone 202 contacts phone subsystem 205 via PSTN 204 by sending information identifying end user unit EUU2.

2. PBX 209 signals the information to state engine 215 via state mnager 214.

3. State engine 215 loads the user state graph from user profile database 208 via state manager 214 and requests detailed user information from the user of end user unit EUU2.

4. State manager 215 send the information to communications link unit N1 via state manager 214 and real time server 207.

5. Using information about the users of end user units EUU1 and EUU2, communications link unit N1 establishes communication link 3 and 4, and, if both end user units EUU1 and EUU2 accept the connection, communication link 5.

6. Communication link 6 may be established via telecommunications web site TCW1. In this case state manager 215 does not send the above information to communications link unit N1.

### EXAMPLE 3

FIGS. 5 and 8 may be used to demonstrate establishment of communications link 12 between first end user unit EUU1 and second end user unit EUU2 using first telecommunications web site TCW1 and second telecommunications web site TCW2. End user unit EUU1 may be employed by a specific entity associated with first telecommunications web site TCW1, while end user unit EUU2 may be employed by a specific entity associated with second telecommunications web site TCW2. End user unit EUU1 desires to establish communications with end user unit EUU2. Telecommunications web site 250 in FIG. 8 corresponds to first telecommunications web site TCW1 in FIG. 5. End user unit 230 and communications link unit 232 in FIG. 8 correspond to end user unit EUU1 and communications link unit N1, respectively, in FIG. 5.

Assumed initiate state of communications environment 200 is as follows: No ongoing calls; no precall (i.e., no call from an end user unit of specific entity SE to telecommunications web site 250 where the telecommunications web site does not yet know where to forward the call, pending, for example the specific entity selecting a calling destination on client 201); specific entity SE is logged on to telecommunications web site 250 with client 201. The chain of events in communications environment 200 is as follows:

1. Telephone 202 contacts phone subsystem 205 via PSTN network 204 by sending information identifying end user unit EUU2.

2. PBX 209 signals the information to state engine 215 via state manager 214.

3. State engine 215 loads the user state graph from user profile database 208 via state manager 214 and requests detailed user information about the user of end user unit EUU2.

4. State manager 215 send the information to communications link unit N1 via state manager 214 and real time server 207.

5. Communications link unit N1 signals end user unit EUU2 the connection desire from end user unit EUU1.

6. End user unit EUU2 signals telecommunications web site TCW2 to establish a connection via telecommunications web site TCW1.

7. Telecommunications web site TCW2 establishes a connection to telecommunications web site TCW1.

8. Communication link 12 is established over the connections from end user unit EUU2 to telecommunications web site TCW2, telecommunications web site TCW2 to telecommunications web site TCW1, and telecommunications web site TCW1 to end user unit EUU1.

In the preceding specification, the present invention has been described with reference to specific exemplary embodiments thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. A method for establishing a communications link between a first end user unit and a second end user unit, comprising:
communicating first web site data from the first end user unit to a first web site, the first web site data being capable of activating the first web site;
determining a first communications link unit using the first web site; and
establishing a first communications link between the first end user unit and the second end user unit via the first communications link unit.

2. The method as recited in claim 1 wherein the first web site is a telecommunications web site associated with the first end user unit.

3. The method as recited in claim 1 further comprising communicating second end user unit data from the first end user unit, the second end user unit data identifying the second end user unit, and wherein the establishing the first communications link between the first and second end user units being performed using the second end user unit data.

4. The method as recited in claim 3 wherein the second end user unit data is communicated to at least one of the first web site and the first communications link unit.

5. The method as recited in claim 1 wherein the first communications link is established via the first web site.

6. The method as recited in claim 1 wherein the first communications link is established via a link used for communicating the first web site data from the first end user unit to the first web site.

7. The method as recited in claim 1 wherein the first communications link is established via an additional link between the first end user unit and the first web site, the additional link replacing a link used for communicating the first web site data from the first end user unit to the first web site.

8. The method as recited in claim 1 wherein the first end user unit includes a first end user device and a first user equipment, the communicating the first web site data being performed using the first end user device and the first communications link being established between the first user equipment and the second end user unit.

9. The method as recited in claim 1 further comprising, in response to the establishing the first communications link, communicating second web site data from the second end user unit to a second web site, the second web site data being configured to activate the second web site.

10. The method as recited in claim 9 wherein the second web site is a telecommunications web site associated with the second end user unit.

11. The method as recited in claim 9 further comprising determining a second communications link unit using the second web site and wherein the establishing the first communications is performed via the second communications link unit.

12. The method as recited in claim 9 further comprising:
determining a second communications link unit using the second web site; and
establishing a second communications link between the first and second end user units via the second communications link unit so as to replace the established first communications link.

13. The method as recited in claim 9 wherein the first communications link is established via the second web site.

14. The method as recited in claim 13 wherein the first communications link is established via a link used for communicating the first web site data from the first end user unit to the first web site.

15. The method as recited in claim 13 wherein the first communications link is established via an additional link between the first end user unit and the first web site, the additional link replacing a link used for communicating the first web site data from the first end user unit to a first web site.

16. The method as recited in claim 11 wherein the first communications link is established via the second web site.

17. The method as recited in claim 12 wherein the first communications link is established via the second web site.

18. The method as recited in claim 9 further comprising at least one of identifying and authenticating the second end user unit using the communicated second web site data.

19. The method as recited in claim 9 wherein the communicated second web site data include at least one of a number code, an alpha-numerical code, data representative of a communications link unit via which a communications link is to be established, data obtained from voice recognition, data indicative of the second end user unit and data identifying a user of the second end user unit.

20. The method as recited in claim 9 wherein at least a portion of the communicated second web site data are communicated by inputting data using at least one of a keyboard, a microphone, a touch screen, a pointing device, a computer, a browser software, and a device for obtaining biometrical data.

21. The method as recited in claim 20 wherein the at least a portion of the communicated second web site data are communicated using a device for automatic data communications under control of the second end user unit.

22. The method as recited in claim 1 further comprising at least one of identifying and authenticating the first end user unit using the communicated first web site data.

23. The method as recited in claim 1 wherein the communicated first web site data include at least one of a number code, an alpha-numerical code, data representative of a communications link unit via which a communications link is to be established, data obtained from voice recognition, data indicative of the first end user unit and data identifying a user of the first end user unit.

24. The method as recited in claim 1 wherein at least a portion of the first web site data are communicated by inputting data using at least one of a keyboard, a microphone, a touch screen, a pointing device, a computer, a browser software, and a device for obtaining biometrical data.

25. The method as recited in claim 1 wherein the at least a portion of the first web site data are communicated using a device for automatic data communications under control of the first end user unit.

26. The method as recited in claim 1 further comprising accounting to the second end user unit costs related to the first communications link.

27. The method as recited in claim 1 wherein at least one of the first and second end user units includes a telephone and wherein the first communications link unit provides public switched telephone network-based communications.

28. An end user unit for communicating with a receiving end user unit, the end user unit comprising:
at least one first unit configured to communicate first web site data to a first web site associated with the end user unit, the first web site data being capable of activating the first web site; and
at least one second unit configured to communicate with the receiving end user unit over a communications link via a first communications link unit determined by the first web site.

29. The end user unit as recited in claim 28 wherein the first web site is a telecommunications web site.

30. The end user unit as recited in claim 28 wherein the at least one first unit is configured to communicate receiving end user unit data, the receiving end user unit data identifying the receiving end user unit and being useable to establish the first communications link.

31. The end user unit as recited in claim 39 wherein the at least one first unit is configured to communicate the receiving end user unit data to at least one of the first web site and the first communications link unit.

32. The end user unit as recited in claim 28 wherein the first communications link is established via the first web site.

33. The end user unit as recited in claim 28 wherein the first communications link includes a link used for communicating the first web site data from the first end user unit to the first web site.

34. The end user unit as recited in claim 28 wherein the first communications link is established via an additional link between the first end user unit and the first web site, the additional link replacing a link used for communicating the first web site data from the first end user unit to a first web site.

35. The end user unit as recited in claim 28 wherein the first communications link is established via a second web site associated with the receiving end user unit.

36. The end user unit as recited in claim 28 wherein the first web site data are capable of at least one of identifying and authenticating the first end user unit.

37. The end user unit as recited in claim 28 wherein the first web site data include at least one of a number code, an alpha-numerical code, data representative of a communications link unit via which a communications link is to be established, data obtained from voice recognition, data indicative of the first end user unit and data identifying a user of the first end user unit.

38. The end user unit as recited in claim 28 wherein the at least one first unit is configured to receive at least a portion of the first web site data by input using at least one of a keyboard, a microphone, a touch screen, a pointing device, a computer, a browser software, and a device for obtaining biometrical data.

39. The end user unit as recited in claim 28 wherein the at least one first unit is configured to communicate at least a portion of the first web site by automatic data communications under control of the first end user unit.

40. The end user unit as recited in claim 28 wherein costs related to the first communications link are accountable to the receiving end user unit.

41. The end user unit as recited in claim 28 wherein at least one of the end user unit and the receiving end user unit includes a telephone and wherein the first communications link unit provides public switched telephone network-based communications.

42. A web site for providing a first communications link between a first end user unit and a second end user unit, comprising:
a web page associated with a user of the end user unit; and
a processor configured to:
receive web site data from the first end user unit, the web site data being capable of activating the web site;
determine a communications link unit, the communications link unit configured to provide communications links; and
initiate an establishment of the communications link between the first end user unit and the second end user unit via the communications link unit.

43. The web site as recited in claim 42 wherein the processor is configured to receive second end user unit data from the first end user unit and to initiate the establishment of the communications link using the second end user unit data, the second end user unit data identifying the second end user unit.

44. The web site as recited in claim 42 wherein the processor is configured initiate the establishment of the communications link using the web site data.

45. The web site as recited in claim 42 wherein the processor is configured to initiate the establishment of the communications link via the web site.

46. The web site as recited in claim 42 wherein the processor is configured to initiate the establishment of the communications link via a link used for receiving the web site data from the first end user unit.

47. The web site as recited in claim 42 wherein the processor is configured to initiate the establishment of the communications link via an additional link between the first end user unit and the web site, the additional link replacing a link used for receiving the web site data from the first end user unit.

48. The web site as recited in claim 42 wherein the communications link is established via a second web site.

49. The web site as recited in claim 42 wherein the web site is configured to at least one of identify and authenticate the first end user unit using the communicated web site data.

50. The web site as recited in claim 42 wherein the web site data include at least one of a number code, an alpha-numerical code, data representative of a communications link unit via which a communications link is to be established, data obtained from voice recognition, data indicative of the first end user unit and data identifying a user of the first end user unit.

51. The web site as recited in claim 42 wherein the web site is configured for having costs related to the communications link are accounted to the second end user unit.

52. A computer readable medium having stored thereon computer executable process steps operative to perform a method for establishing a communications link between a first end user unit and a second end user unit, comprising:
receiving, at a web site, web site data from the first end user unit, the web site data being capable of activating the web site;
determining a communications link unit, the communications link unit configured to provide communications links; and
initiating an establishment of the communications link between the first end user unit and the second end user unit via the communications link unit.

53. The computer readable medium as recited in claim 52 wherein the web site is a telecommunications web site associated with the first end user unit.

54. The computer readable medium as recited in claim 52 wherein the method further comprises receiving second end user unit data from the first end user unit and initiating the establishment of the communications link using the second end user unit data, the second end user unit data identifying the second end user unit.

55. The computer readable medium as recited in claim 52 wherein the method further comprises accounting to the second end user unit costs related to the first communications link

56. A communications environment comprising:
a first end user unit; and
a web site associated with the first end user and configured to:
receive web site data from the first end user unit, the web site data being capable of activating the web site;
determine a communications link unit, the communications link unit configured to provide communications links; and
initiate an establishment of the communications link between the first end user unit and a second end user unit via the communications link unit.

57. The communications environment as recited in claim 56 wherein the web site is configured to receive second end user unit data from the first end user unit and to initiate the establishment of the communications link using the second end user unit data, the second end user unit data identifying the second end user unit.

58. The communications environment as recited in claim 56 wherein the web site is configured initiate the establishment of the communications link using the web site data.

59. The communications environment as recited in claim 56 wherein the web site is configured to initiate the establishment of the communications link via the web site.

60. The communications environment as recited in claim 56 wherein the web site is configured to initiate the establishment of the communications link via a link used for receiving the web site data from the first end user unit.

61. The communications environment as recited in claim 56 wherein the web site is configured to initiate the establishment of the communications link via an additional link between the first end user unit and the web site, the additional link replacing a link used for receiving the web site data from the first end user unit.

62. The communications environment as recited in claim 56 wherein the communications link is established via a second web site.

63. The communications environment as recited in claim 56 wherein the web site is configured to at least one of identify and authenticate the first end user unit using the communicated web site data.

64. The communications environment as recited in claim 56 wherein the web site data include at least one of a number code, an alpha-numerical code, data representative of a communications link unit via which a communications link is to be established, data obtained from voice recognition, data indicative of the first end user unit and data identifying a user of the first end user unit.

65. The communications environment as recited in claim 56 wherein the web site is configured for having costs related to the communications link are accounted to the second end user unit.
